(19) United States
(12) Patent Application Publication
(10) Pub. No.: US 2013/0161334 A1
(43) Pub. Date: Jun. 27, 2013

(54) STRUCTURE OF ENAMELWARE

(71) Applicant: Shu-Tien Liu, Bangkok (TH)

(72) Inventor: Shu-Tien Liu, Bangkok (TH)

(73) Assignee: Thai First Enamel Co., Ltd., Bangkok (TH)

(21) Appl. No.: 13/337,333

(22) Filed: Dec. 27, 2011

(51) Int. Cl. A47J 27/00

(52) U.S. Cl. 220/573.1

(57) ABSTRACT

An improved structure of enamelware which ensures the glaze can be coated homogeneously and tightly onto the surface of the enamelware, characterized in that: the edge portion of the metal substrate is pressed to form a spherical block in cross-section, therefore the surface area of the edge of the enamelware is enlarged, such that the glaze can be homogeneously and tightly coated onto the edge portion of the enamelware to provide the anti-rust function and maintain the beauty of enamel.

### BACKGROUND OF THE INVENTION

### Field of the Invention

The present invention relates to an improved structure of enamelware, particularly relates to a structure which ensures compacting and smoothing of the glaze coating on the edge surface of enamelware, therefore enhancing the beauty and durability of the enamelware.

### BACKGROUND OF THE INVENTION

Enamel is a skill of metalwork originated in Europe and lasting in China for a long time. The fabrication of enamelwares is to uniformly glaze onto the surface of a metal substrate. It is known to the public that the expansion coefficient of glaze is smaller than that of metal substrate, and the melting point of glaze is also lower than that of the metal substrate. Such that the glaze can be uniformly applied to the surface of the ware, so as to glorigy the ware and prevent the metal substrate of enamelware from oxidation. The drawbacks of general enamelware are listed as follows:
1. Referring to FIGS. 1A and 1B, the general enamelware set comprises a lid 100 and a main body 200, they are formed by stamping the metal plate with definite thickness respectively.

Referring to FIG. 1B and FIG. 2, the edge portion 100A [symbol] 200A of the respective lid 100 and the main body 200 also the edge portion 300A of the spout 300 show portions which are difficulty to be coated, causing the glaze on the edge portions are thinner or partially peel off. Moreover, the metal substrate will soon be rusted after the enamelware is done. To improve the rust phenomenon of metal substrate resulting from the non-uniformity of glaze on the edge portion of enamelware edge, Taiwan Patent of Utility Model No. 74208273 discloses an improved structure of edge of steel enamelware which comprises a container body made of steel and covered by a layer of enamel on both interior surface and exterior surface, characterized in that: the anti-rust material is electroplated onto the top edge of enamelware and therefore enveloping the edge portion where the glaze is hard to be coated onto, and functioned as preventing the metal substrate from the air to the oxidation. Though this technique completely prevents the metal substrate from the air, however the preparation and the process of electroplating increases the manufacturing cost. Moreover, electroplating material is incompatible with the glaze material causing the non-uniform distribution of glaze material on the metal substrate.
2. In consideration with said defect of double processing, as shown in FIG. 3, a ring of sheath 100B [symbol] 200B is mounted on the edge of the lid 100 and the main body 200 respectively. Taiwan Patent of Utility Model M258693 [symbol] 80203794 both disclose an improved structure of the edge of enamel pot, which is mounted with a ring shaped silicon sheath and stainless-steel sheath sequentially. The silicon sheath is made of non-toxic and heat-resistant silicon and wrapped the surface of the edge of the pot while the stainless-steel sheath hoops the edge of the pot. Whereas the preparation of silicon sheath and stainless-steel sheath not only cause the increase of manufacturing cost, due to the accumulation of moisture and bacterium inside the sheaths but also cause the oxidation of the metal substrate of the enamelware. In addition, the intersection portions of the sheath and the lid or the main body 1000 [symbol] 100D [symbol] 200C [symbol] 200D also appear non-uniform thickness of the glaze compared to other parts of the enamelware.

### SUMMARY OF THE INVENTION

The main object of present invention is to provide an improved structure of enamelware. By way of pressing the edge portion of the metal substrate of enamelware, the surface area of the edge shall be thickened and expanded. According to the improved structure of enamelware of present invention, the glaze can be easily and uniformly applied onto the edge of the metal substrate, and the enamelware made by this method still keep the beauty. This is another object of present invention.

According to the improved structure of present invention, the edge of the metal substrate of enamelware does not have to be mounted with a sheath, and no perplexity of raising cost for manufacturing and material because of the sheath. This is the third purpose of present invention.

According to the improved structure of enamelware of present invention, the metal substrate of enamelware does not have to be mounted with a sheath, therefore there is no interstice between the metal substrate of enamelware and the sheath and therefore no oxidation of the metal substrate of enamelware will be happened due to the bacterium and moisture accumulation. This is further object of present invention.

According to the improved structure of enamelware of present invention, the manufacturing process thereof does not have the step of covering the edge of metal substrate of enamelware with a layer of anti-rust material through additional electroplating step, such that the beauty and durability will not be affected by the non-uniformity of the electroplating layer and the incapable fusion of anti-rust material and the glaze. Meanwhile, the production cost will not be raised due to the additional electroplating process. This is an additional object of present invention.

The above objects and other advantages of the present invention will become more apparent by describing in detail the preferred embodiment of the present invention with reference to the attached drawings.

### BRIEF DESCRIPTION OF THE DRAWINGS

FIG. 1A is an illustration showing the main construction of the enamelware

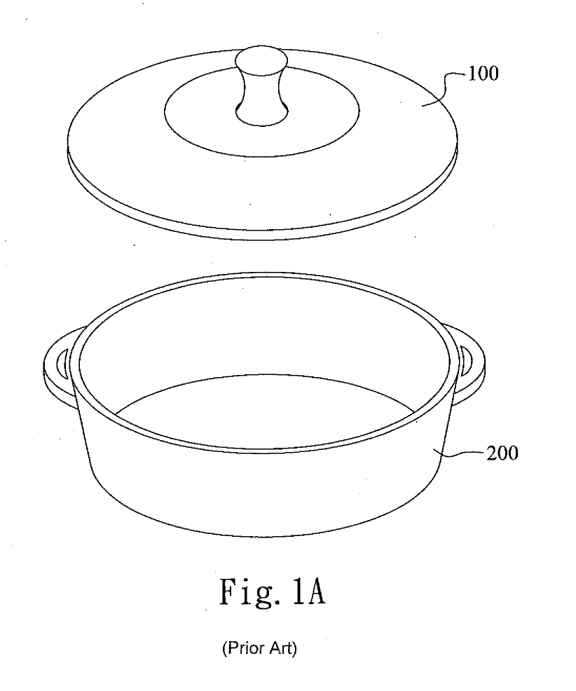

FIG. 1B is another illustration showing the main construction of the enamelware

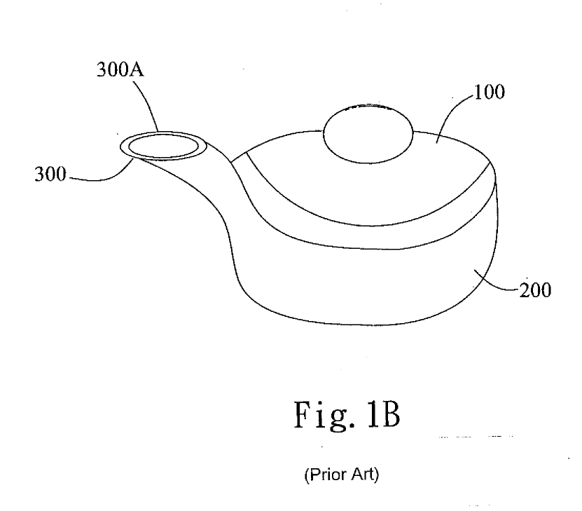

FIG. 2 is an illustration showing the structure of the edge portion of enamelware in an embodiment of prior art

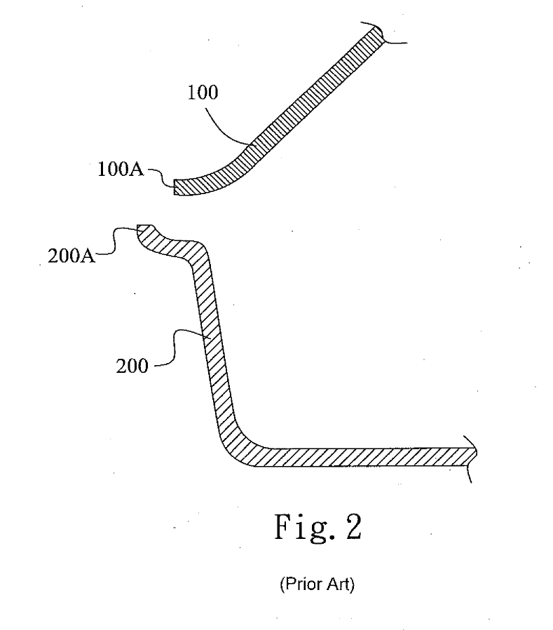

FIG. 3 is illustration showing the structure of the edge portion of enamelware in another embodiment of prior art.

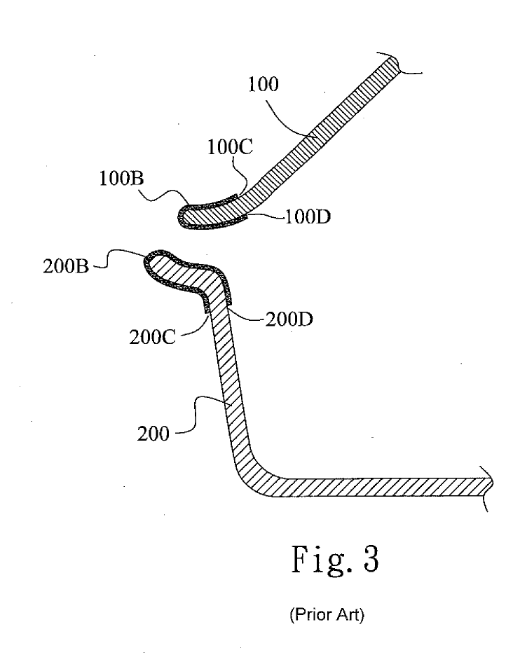

FIG. 4 is a longitudinal view of the enamelware set of present invention.

FIG. 5 is an illustration of sectional view showing the edge of the lid and the main body in the preferred embodiment of present invention.

### DETAILED DESCRIPTION OF THE PREFERRED EMBODIMENTS

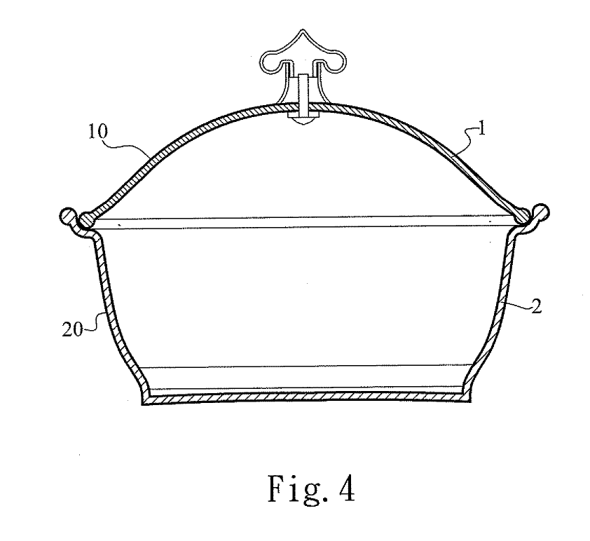

Referring to FIG. 4, the enamelware of present invention comprises a main body 2 whose substrate is made by a monolithic metal material. Inside the main body 2, there is a sufficient space with a depth to keep all kinds of foodstuff or drinkable liquids even other object. The interior and exterior surfaces of the metal substrate are coated with the glaze 10.

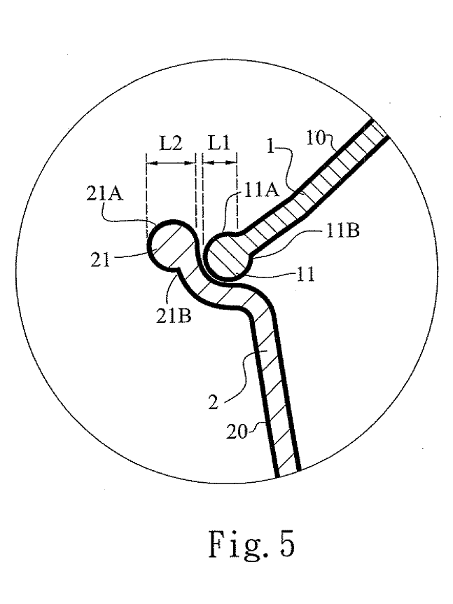

As shown in FIG. 5, the enamelware of present invention where the edge portion of the main body 2 is formed as a spherical block 21 in longitudinal cross-section. The spherical block 21 can be formed by pressing the edge of the metal substrate after the metal substrate of the main body 2 is manufactured. As to the spherical block 21, the width L2 is preferably 0.1-1 cm, so the radius of said block is preferably 0.05 to 0.5 cm. And the intersection 21B of the bottom of spherical block 21 and the main body 2 is smoothly jointed together to form a unit.

According to the above-mentioned embodiment, the main body 2 of the enamelware of present invention may be the pot, the kettle, the plate, the bowl, the cup and the tub, etc.

As shown in FIG. 4, the another embodiment of preferred embodiment enamelware of present invention also include a lid 1. The substrate of the lid 1 is still a monolithic metal, and both the interior and the exterior surfaces of the metal substrate are coated by a layer of glaze 10. Inside the lid 1 is a upward concaved bulged space.

As shown in FIG. 5, the edge portion of the lid 1 of the enamelware of present invention is preferably formed as a spherical block 11 in longitudinal cross-section. After the metal substrate of the lid is manufactured, by using the method of molding and pressing the edge portion having spherical block 11 in cross-section is formed. The width L2 of the said spherical block 11 is preferably 0.1-1 cm.

According to the above-mentioned embodiment, the lid of the enamelware of present invention may be the pot cover, the kettle lid, the cup cover and the tub lid, etc.

The enamelware of present invention, in addition to the above-mentioned spherical block in longitudinal cross-section formed with the edge portions of both main body 2 and lid 1, also may be the ellipsoid in cross-section, or the edge block having a smooth and a proper thickness.

From the above description, it can be seen that the improved structure of present invention indeed can enlarge the surface area also the thickness the edge portion of the enamelware, and further amend the defects of non-uniformity of the glaze and bacterium accumulation inside the stainless-steel sheath occurred in conventional enamelwares. Also, the present invention has not yet been opened to public; it is then complied with the conditions of allowable patents.

Although the above-mentioned embodiments of the present invention have been described for illustrative purposes, those skilled in the art will appreciate that various modifications, additions and substitutions are possible, without departing from the scope and spirit of the invention as disclosed in the accompanying claims.

1. An improved structure of enamelware which comprises a main enameled body container with a sufficient space in depth, wherein an edge portion of the main body is formed as a spherical block in cross section, such that said edge portion enlarges the thickness and the surface area of the edge portion of enamelware, and an enamel glaze on the surface of the edge portion is compactly and uniformly coated thereon.

2. The improved structure of enamelware as claimed in claim 1, wherein the edge portion of the main body of enamelware is a spherical block, an ellipsoid, or an edge portion which is smooth and thick.

3. The improved structure of enamelware as claimed in claim 1, wherein the width of the block of the edge portion is 0.1 to 1 cm, therefore the radius of the block of the edge portion is 0.05-0.5 cm.

4. The improved structure of enamelware as claimed in claim 1, wherein the intersection of said spherical-block edge portion is in a smooth connection with other portion of the main body.

5. The improved structure of enamelware as claimed in claim 1, the main body is for storing articles and is provided with the lid function of covering.

6. The improved structure of enamelware as claimed in claim 1, wherein the main body is a pot, a kettle, a plate, a bowl, a cup or a tub.

7. The improved structure of enamelware as claimed in claim 1, wherein the main body is capped with an enamel lid.

8. (canceled)

9. The improved structure of enamelware as claimed in claim 7, where in the enamel lid is a pot carver, a kettle lid, a cup cover or a tub lid.
